(19) United States
(12) Patent Application Publication
(10) Pub. No.: US 2006/0026744 A1
(43) Pub. Date: Feb. 9, 2006

(54) Outfit for rider of riding type vehicle

(76) Inventor: Koji Tsuya, Iwata-Shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/197,116

(22) Filed: Aug. 4, 2005

(30) Foreign Application Priority Data
Aug. 9, 2004 (JP) 2004-231837

(51) Int. Cl. A41D 13/12; B62J 1/28

(52) U.S. Cl. 2/456; 280/304.4

(57) ABSTRACT

A riding suit can be provided with a main body worn by a rider in a tight-fitting manner. A wind diverting member can be attached to the main body. The wind diverting member can be attached to an outer side portion of the main body. In a side view of the rider riding on a vehicle in a crouching position, a space interposed by one portion and other portions of the main body is closed and/or substantially closed by the wind diverting member. Respective outer side faces of the one portion, the other portions, and the wind diverting member are arranged substantially on a single imaginary curved face.

### PRIORITY INFORMATION

This application is based on and claims priority under 35 U.S.C. § 119 to Japanese Patent Application No. 2004-231837, filed on Aug. 9, 2004, the entire contents of which is hereby expressly incorporated by reference.

### BACKGROUND OF THE INVENTIONS

1. Field of the Inventions

The present inventions relate to clothing for a rider of a riding type vehicle, and more particularly, to riding suits having wind diverting members.

2. Description of the Related Art

Riding suits have long been used for protecting motorcycle riders. Some known riding suits include wind diverting members. For example, Japanese Utility Model Publications JP-UM-A-58-135411, JP-UM-B-59-5686, JP-UM-A-59-125917, and JP-UM-B-2-16965 disclose such riding suits. The riding suits shown in these publications include a tight-fitting main body and a wind diverting member attached to the main body.

The wind diverting members shown in Japanese Utility Model Publications JP-UM-A-58-135411, JP-UM-B-59-5686, and JP-UM-A-59-125917 are attached to a portion of the main body in the vicinity of the upper portion of the arm of the rider. These wind diverting members extend rearwardly from the arm portion. When these suits are worn by riders, the combination of the upper arm portions of the suits and the wind diverting members form a streamline shape.

This streamline shape helps to reduce the occurrence and magnitude of vortexes that are normally generated by the flow of air over the body of a rider during operation of a riding type vehicle. As a result, an air resistance generated by the rider's body is reduced, thus making the riding experience more comfortable and increasing fuel efficiency.

The wind diverting member described in Japanese Utility Model Publication JP-UM-B-2-16965 is attached to a portion of the main body of the riding suit corresponding to an upper portion of the back of the rider, and extends upwardly therefrom. In this design, the entire space between the head and upper back of the rider is covered with the wind diverting member. Covering this space with the wind diverting member as such prevents a large negative pressure from being generated behind the rider's head. As a result, the air resistance is reduced, providing a more comfortable riding experience for the rider, and improving fuel efficiency.

### SUMMARY OF THE INVENTIONS

During operation of the wind diverting members described in Japanese Utility Model Applications JP-UM-A-58-135411, JP-UM-B-59-5686, and JP-UM-A-59-125917, a region rearward from the upper portion of the arm is opened to an outer side and thus, a negative pressure is generated by the wind. This generates a substantial amount of wind resistance that can be further reduced.

The wind diverting member described in Japanese Utility Model Application JP-UM-B-2-16965 fills the space over a total width of the rider and vehicle. Therefore, an outer shape of the wind diverting member is large, and further, a weight thereof is likely to be heavy. Thus, this design places an excessive burden on the rider.

An aspect of at least one of the embodiments disclosed herein includes the realization that a more effective and more efficient manner for reducing wind resistance generated by a rider that is exposed to the wind during the operation of a riding-type vehicle is to connect a wind diverting member to an outer side portion of the main body of the suit worn by the rider. The outer side portion can be, for example, but without limitation, a portion of the main body of the riding suit that is positioned over a side of the rider's torso. As such, the wind diverting member can more effectively prevent a negative pressure from being generated rearward of a rider's upper arm.

Another aspect of at least one of the embodiments disclosed herein includes the realization that arranging a wind diverting member along an imaginary curve defined at least partially by parts of the suit worn by the rider that are adjacent to the wind diverting member provides a more aerodynamic shape, and thus reduces the wind resistance and provides a more comfortable ride for the rider.

Thus, in accordance with an embodiment, a riding suit for a rider of a riding type vehicle comprises a main body configured to be worn by a rider in a tight-fitting manner and a wind diverting member attached to the main body. The wind diverting member can be attached to an outer side portion of the main body such that, in a side view of the rider riding on the vehicle in a crouching position, a space disposed between a first portion and a second portion of the main body is substantially closed by the wind diverting member. Additionally, respective outer side faces of the first and second portions and the wind diverting member can be arranged substantially along a single imaginary curved surface.

In accordance with another embodiment, a riding suit for a rider of a riding type vehicle can comprise a main body configured to be worn by a rider in a tight-fitting manner and means for diverting wind around a space between first and second portions of a rider riding on a vehicle in a crouching position, along a single imaginary curved surface defined at least in part by outer facing surfaces of the first and second portions.

### BRIEF DESCRIPTION OF THE DRAWINGS

The above-mentioned and the other features of the inventions disclosed herein are described below with reference to the drawings of the preferred embodiments. The illustrated embodiments are intended to illustrate, but not to limit the inventions. The drawings contain the following figures:

FIG. 1 is a schematic side elevational view of a rider wearing a riding suit in accordance with an embodiment and riding a riding-type vehicle.

FIG. 2 is a partial plan view of the rider and the riding suit shown in FIG. 1

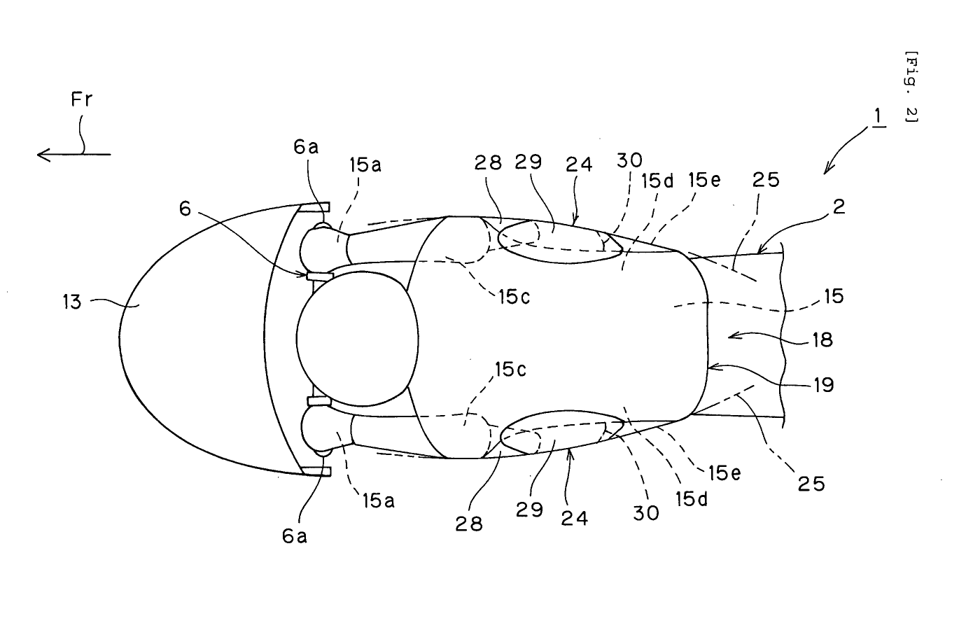

### DETAILED DESCRIPTION OF THE PREFERRED EMBODIMENT

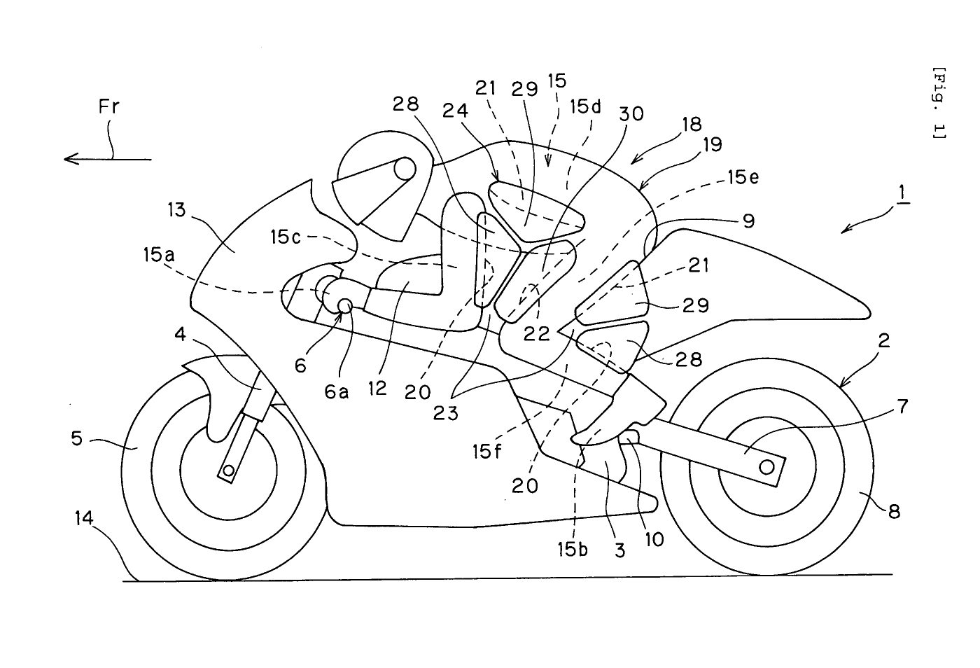

With reference to FIG. 1, a motorcycle 1 is an example of a riding type vehicle with which the inventions disclosed herein can be used. The embodiments disclosed herein are described in the context of a riding suit for a motorcycle rider because the embodiments disclosed herein have particular utility in this context. However, the embodiments and inventions herein can also be applied to clothing used for other activities such as, for example, but without limitation, sporting activities, or for operating other types of vehicles, such as watercraft, all terrain vehicles, aircraft, and the like.

For reference, an arrow Fr designates a front side in an advancing direction of the vehicle 1. As used herein, the terms “front,” “rear,” “left,” “right,” “up” and “down,” correspond to such directions as viewed by a driver of the motorcycle 1.

The illustrated riding suit includes a main body that is configured to be worn by a rider in a tight-fitting manner. Additionally, the riding suit includes a wind diverting member attached to the main body. The wind diverting member is attached to an outer side portion of the main body, in a side view of the rider riding thereon in a crouching position. A space between two portions of the main body is closed and/or substantially closed by the wind diverting member. Initially, however, a riding-type vehicle is described below to provide one exemplary but non-limiting environment of use of the riding suit.

As shown in FIG. 1, a vehicle body 2 of the motorcycle 1 is provided with a vehicle body frame 3. A front fork 4 is axially supported by a front end portion of the vehicle body frame 3, so as to be steerable. A front wheel 5 is supported by a lower end portion of the front fork 4. A handlebar 6 is supported by an upper end portion of the front fork 4.

A rear swing arm 7 is axially supported by a rear portion of the vehicle body frame 3 so as to be pivotable in an up and down direction. A rear wheel 8 is supported by a pivoting end portion of the rear arm 7. A seat 9 is supported by an upper portion of the vehicle body frame 3, and a pair of left and right foot rests 10 are arranged on a rear lower side of the seat 9, so as to project from a rear lower portion of the vehicle body frame 3.

An engine, not illustrated, can also be supported by the vehicle body frame 3. Further, a fuel tank 12 for storing fuel supplied to the engine can be supported by an upper portion of the vehicle body frame 3, with the fuel tank 12 arranged forwardly from the seat 9. Additionally, the vehicle body 2 can be provided with a front cowling 13 covering the forwardly facing portion of the vehicle body 2. The front cowling 13 can be fixed to the vehicle body frame 3.

The front wheel 5 and the rear wheel 8 ride along the ground, referred to as a running road face 14, thereby supporting the vehicle 1 on the running road face 14. In the illustrated example, a rider 15 is seated to ride on the seat 9. Riders, such as the rider 15, can grab respective grips 6a of the handle 6 with their hands 15a. Riders can also rest their feet 15b on the respective foot rests 10 while riding on the vehicle 1 in a crouching position, or other positions.

The front cowl 13 covers substantially all of the forward facing surfaces of the rider 15 when the rider 15 is in the crouching position. In this case, respective outer side faces of the front cowl 13 and those of the rider 15 are arranged at locations substantially the same as each other in the width direction of the vehicle 1. Further, an imaginary face extending rearwardly from the upper face of the front cowl 13 substantially coincides with an upper face of the head portion of the rider 15.

The rear wheel 8 is driven to rotate by a drive force from the engine o the vehicle 15. By driving the rear wheel 8, the vehicle 1 is runs toward the front side of the vehicle on the running road face 14.

The rider 15 wears an outfit 18. During forward motion of the vehicle 1, an air resistance applied to the rider 15 by a running wind is reduced by the outfit 18. The outfit 18 can be provided with a main body 19 worn by the rider 15 in a tight-fitting manner and a wind diverting member 24 is attached to the main body 19.

The wind diverting member 24 can be made to be light-weight and rigid by being formed by foamed resin or any other light and rigid material. An outwardly facing side face of the wind diverting member 24 can comprise a smooth curved convex surface. Two wind diverting members 24 can be attached to the respective left and right outer side portions of the main body 19 respectively, in a cantilever manner. For example, one or more edges of the wind diverting member 24 can be attached to the main body 19 while one or more other edges of the wind diverting member 24 can be free. However, other attachment methods and configurations can also be used. In some embodiments, the outer side portion can be a portion corresponding to a side surface of the torso of the rider 15.

Further, when viewed in a side elevational view of the rider 15 riding on the vehicle in the crouching position, a space 23 is formed between one portion 20 and other portions 21, 22 of the main body 19. In some embodiments, this space can be at least partially covered or substantially closed by the wind diverting member 24. Respective outer side faces of the one portion 20, the other portions 21, 22 of the main body 19 and the wind diverting member 24 can be arranged substantially on a single imaginary curved face 25 having a smooth curved face in a shape convex to an outer side. Further, the imaginary curved face 25 is extended along a longitudinal direction and a vertical direction of the vehicle 1.

The one portion 20 and the other portions 21, 22 can comprise portions corresponding to any of an upper portion 15c of the arm, the side 15d and an upper portion 15e of the leg and a lower portion 15f of the leg of the rider 15, an/or other portions. In some embodiments, the one portion 20 can correspond to the upper portion 15c of the arm, the other portion 21 can correspond to the side 15d and the further other portion 22 can correspond to the upper portion 15e of the leg. Further, the one portion 20 can correspond to the lower portion 15f of the leg and the other portion 21 can correspond to the upper portion 15e of the leg.

The wind diverting member 24 can be provided with a first wind diverting member 28 attached to the portion 20, a second wind diverting member 29 attached to the other portion 21, and another second wind diverting member 30 attached to the other portion 22. In some embodiments, the first and the second wind diverting members 28-30 can be separate from each other. Further, in some embodiments, respective outer side faces of the first, the second wind diverting members 28-30 can be arranged substantially on the imaginary curved face 25. Further, in some embodiments, edge portions of respective projected edge portions of the first, the second wind diverting members 28-30 opposed to each other can be made to be proximate to (or brought into contact with) each other over substantially the entirety of the respective edge portions. Thereby, the respective spaces 23 are substantially closed as a whole by the wind diverting member 24.

According to some of the above-described embodiments, the wind diverting member 24 is attached to the outer side portion of the main body 19, in a side view (FIG. 1) of the rider 15 riding on the vehicle in the crouching position, the space 23 interposed by the one portion 20 and the other portions 21, 22 of the main body 19 is closed or substantially closed by the wind diverting member 24. Additionally, the respective outer side faces of the one portion 20, the other portions 21, 22 and the wind diverting member 24 can be arranged substantially on the single imaginary curved face 25. This provides an additional advantage in providing a more aerodynamic air flow around the rider 15.

Thus, regions rearward from the one portion 20 or the other portions 21, 22 in the space 23 are covered or substantially covered by the wind diverting member 24 from the outer side. Therefore, during forward running of the vehicle 1, the airflow over the rider 15 is improved, thus reducing the likelihood that a negative pressure is generated at the regions rearward from the one portion 20 or the other portions 21, 22 in the space 23 by the running wind flowing to a rear side at the outer side of the rider 15. Further, the running wind is made to flow to the rear side smoothly along the respective outer side faces. As a result, an air resistance applied to the rider 15 by the running wind is further reduced and thus the rider 15 is provided with a smoother and more comfortable riding experience.

Further, as described above, the wind diverting member 24 is attached to the outer side of the main body 19. Thus, in comparison with other the wind diverting members, such as those noted above in the Background section, which embed the space 23 over the total width direction of the vehicle 1, the outer shape of the wind diverting member 24 having the above-described constitution can be made smaller and lighter-weight. Thus, even when the wind diverting member 24 is provided, the burden on the rider 15 generated by wind resistance can be reduced.

In the above-described case, the front cowl 13 covers the rider 15 as a whole from the front side. Thus, the running wind is prevented from being directed to a space between the upper portion of the vehicle body frame 3 and the fuel tank 12 and the upper body of the rider 15 by the front cowl 13. Therefore, the running wind is prevented from flowing between the left and right wind diverting members 24 which would increase the air resistance.

Further, as described above, the one portion 20 and the other portions 21, 22 are configured to correspond to any of the upper portion 15c of the arm, the side 15d, the upper portion 15e of the leg and the lower portion 15f of the leg of the rider 15.

Thus, any of the one portion 20 and the other portions 21, 22 of the main body 19 can be disposed at the outer side portion of the main body 19. Even when the one portion 20 and the other portions 21, 22 are specifically configured for any specific portion of the main body 19, based on the running wind flowing toward the rear side at the outer side of the rider 15, the wind resistance generated against the rider 15 is further reduced and smoother running can be carried out.

Further, as described above, the wind diverting member 24 can be provided with the first wind diverting member 28 attached to the one portion 20 and the second wind diverting members 29, 30 attached to the other portions 21, 22, with the respective outer side faces of the first, the second wind diverting members 28-30 arranged substantially on the imaginary curved face 25. In some embodiments, the wind diverting member 24 can be divided into a plurality of the members 28-30 with these respective members 28-30 attached to the respective portions 20-22 of the main body 19.

As such, firstly, the burden or pressure on the rider 15 generated by the wind diverting member 24 is dispersed over respective portions of the rider 15. Thus, for example, when the rider 15 changes a riding position during forward movement of the vehicle 1, such a change can smoothly and swiftly be carried out and the maneuverability is excellently maintained.

Additionally, attachment of the wind diverting member 24 to the main body 19 is dispersed to the respective portions 20-22 of the main body 19. Therefore, in comparison with attachment of the single and large-sized wind diverting member 24 to one portion of the main body 19, there is achieved an effect of facilitating to ensure respective strengths of attaching the wind diverting member 24 to the main body 19.

Further, as described above, the edge portions of the respective projected edge portions of the first, the second wind diverting members 28-30 opposed to each other are made to be proximate to each other. Thus, the space 23 is substantially totally closed by the wind diverting member 24. Therefore, the air resistance is reduced and further smoothing the ride experienced by the rider 15.

Further, as described above, in some embodiments, the one portion 20 can correspond to the upper portion 15c of the arm and the other portion 21 can correspond to the side 15d. Generally, at the region rearward from the upper portion 15c of the arm in the space 23 interposed by the upper portion 15c of the arm and the side 15d of the rider, the large negative pressure is liable to be generated by the running wind. However, the negative pressure can be prevented from being generated by the wind diverting member 24. Therefore, the air resistance applied to the rider 15 by the running wind is reduced and providing a smoother ride.

Additionally, as described above, in some embodiments, the one portion 20 can corresponds to the upper portion 15c of the arm, the other portion 21 can correspond to the side 15d, and the further other portion 22 can correspond to the upper portion 15e of the leg. Here, generally, at the region rearward from the upper portion 15c of the arm in the space 23 interposed by the upper portion 15c of the arm, the side 15d and the upper portion 15e of the leg of the rider 15, the large negative pressure is liable to be generated by the running wind. However, the negative pressure is prevented from being generated by the wind diverting member 24. Therefore, the air resistance applied to the rider 15 by the running wind is reduced and providing a smoother ride.

In some embodiments, as noted above, the one portion 20 can be made to correspond to the lower portion 15f of the leg and the other portion 21 can be made to correspond to the upper portion 15e of the leg. Here, generally at the regions rearward from the upper portion 15e of the leg and the lower portion 15f of the leg in the space 23 disposed by the upper portion 15e of the leg and the lower portion 15f of the leg of the rider 15, the large negative pressure is liable to be generated by the running wind. However, the negative pressure is prevented from being generated by the wind diverting member 24. Therefore, the air resistance applied to the rider 15 by the running wind is reduced and providing a smoother ride.

Further, although the above-described embodiments are described in the context of a two-wheeled motorcycle, the riding type vehicle can be any type of vehicle, such as an automatic three-wheel vehicle, an automatic four-wheel vehicle, or a bicycle. Further, the wind diverting member 24 can be formed by an elastic member of sponge, rubber or the like. Further, a locking piece of a face tape or the like for locking edge portions of the first, the second wind diverting members 28-30 opposed to each other engageably or and disengageably to and from each other can also be provided.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A riding suit for a rider of a riding type vehicle comprising a main body configured to be worn by a rider in a tight-fitting manner and a wind diverting member attached to the main body, the wind diverting member being attached to an outer side portion of the main body such that, in a side view of the rider riding on the vehicle in a crouching position, a space disposed between a first portion and a second portion of the main body is substantially closed by the wind diverting member and respective outer side faces of the first and second portions and the wind diverting member are arranged substantially along a single imaginary curved surface.

2. The riding suit according to claim 1, wherein the first and second portions correspond to at least two of an upper portion of an arm of the main body, the outer side portion, an upper portion of the leg of the main body and a lower portion of the of the main body.

3. The riding suit according to claim 1, wherein the wind diverting member comprises a first wind diverting member attached to the first portion and a second wind diverting member attached to the second portion, and wherein respective outer side faces of the first and the second wind diverting members are arranged substantially on the imaginary curved surface.

4. The riding suit according to claim 3, wherein the edge portions of respective projected edge portions of the first and the second wind diverting members opposed to each other are configured to be proximate to each other when the riding suit is worn by a rider in a position for operation of the vehicle.

5. The riding suit according to claim 1, wherein the first portion corresponds to an upper portion of the arm and the second portion corresponds to the outer side portion.

6. The riding suit according to claim 1, wherein the first portion corresponds to an upper portion of the arm, the second portion corresponds to the outer side portion, and a third portion of the main body corresponds to an upper portion of a leg, an outer side face of the third portion also being arranged along the single imaginary curved surface.

7. The riding suit according to claim 2, wherein the first portion corresponds to the lower portion of the leg and the second portion corresponds to the upper portion of the leg.

8. The riding suit according to claim 1, wherein the outer side portion of the main body corresponds to a laterally-facing side of a torso of a rider.

9. A riding suit for a rider of a riding type vehicle comprising a main body configured to be worn by a rider in a tight-fitting manner and means for diverting wind around a space between first and second portions of a rider riding on a vehicle in a crouching position, along a single imaginary curved surface defined at least in part by outer facing surfaces of the first and second portions.

10. The riding suit according to claim 9 additionally comprising means for substantially covering the entire space.
